(19) United States
(12) Patent Application Publication
(10) Pub. No.: US 2024/0414463 A1
(43) Pub. Date: Dec. 12, 2024

(54) BODY ADHESION DEVICE FOR MICROPHONES AND OTHER DEVICES

(71) Applicant: Jacquita Lynn Thomassen, St. George, UT (US)

(72) Inventor: Jacquita Lynn Thomassen, St. George, UT (US)

(21) Appl. No.: 18/738,757

(22) Filed: Jun. 10, 2024

Related U.S. Application Data
(60) Provisional application No. 63/507,053, filed on Jun. 8, 2023.

(51) Int. Cl. H04R 1/08

(52) U.S. Cl. CPC H04R 1/08

(57) ABSTRACT

A body adhesion device provides a reliable means of adhering a microphone, tube, or cable to a user's face or body that is resistant to peeling off during use and allows the user to easily remove and replace the microphone, tube, or cable. A body adhesion device features a first surface opposite a second surface, the first surface having an elevated element, a first aperture, a second aperture, and a channel therebetween such that a microphone, tube, or cable may be secured through insertion of the microphone, tube, or cable into the channel. A second surface having an adhesive layer that is coextensive with the second surface allows a user to peel away a release liner and adhere the device to the desired location on the user's face or body.

### CROSS-REFERENCE TO RELATED APPLICATIONS

This application claims the benefit of U.S. Provisional Application Ser. No. 63/507,053, filed on Jun. 8, 2023, which is incorporated herein by reference.

### TECHNICAL FIELD

The present disclosure relates to a means for adhering a microphone or other device (e.g., cable, tubing, etc.) to a user's body. More particularly, the present disclosure relates to a sweat-resistant adhesion device that is configured to receive a microphone or other device for use on the body.

### BACKGROUND

Theatrical performances, music concerts, and related entertainment services depend on professional microphones to capture clear audio input that can be transmitted to the farthest attendees in a venue. While larger, traditional microphones are appropriate in some venues, smaller, more manipulable microphones, known as lavalier or body microphones, are preferred. These lavalier or body microphones may be adhered to the user's face or body to facilitate the user's free movement around the stage and to remove the distraction caused by the user carrying the microphone in their hands.

Such lavalier microphones are traditionally adhered to the user's face through placement of a base layer of surgical or athletic tape, placement of the microphone on top of the base layer, and then placement of yet another piece of tape to secure the microphone in place. Yet, as the user sweats and moves around the stage, the tape often begins to detach from the user's skin and falls off midperformance. Additionally, between acts of a play, for example, or other moments off stage, a user may wish to temporarily remove the microphone to switch costumes, eat food, or simply ensure that conversations are not transmitted to the audience. In such moments, users must completely remove the old tape, retouch any makeup, wigs, hats, or prosthetics that were disturbed, and then use new tape to again adhere the microphone to the body before rejoining the performance.

Alternative microphone arrangements including lapel clips attached to clothing, custom harness systems, and headsets can be expensive, distract the audience, and/or fail to position the microphone close enough to the user's mouth to collect the best sound quality that limits ambient noise. Thus, there is a need for a reliable means of adhering a microphone to a user's face or body that also allows the user to easily remove and replace the microphone during performances.

In addition to the entertainment industry, other industries, such as the medical industry, could also benefit from a better body adhesion means. For example, when a user is receiving an intravenous (IV) infusion or has an electrical monitoring device attached to their body, a caregiver commonly uses a piece of tape to adhere the tube or cable to the body. This tape is frequently much larger than the area needed for the tube or cable, which results in additional skin and hair being subjected to the adhesive. This may not only irritate the user's skin and hair when applied, but is especially irritating when removed. As a result, there is a need for an adhesion device for tubes, cables, and other devices that does not require estimation on the part of the caregiver and that is only adhered in a small diameter/circumference.

The present disclosure seeks to solve these and other problems.

### SUMMARY OF EXAMPLE EMBODIMENTS

In some embodiments, a body adhesion device comprises a first surface opposite a second surface, the first surface comprising an elevated element, a first aperture, a second aperture, and a channel therebetween such that a microphone body may be secured within the channel through insertion of the microphone through the first aperture, through the channel, and out of the second aperture. The second surface comprises an adhesive layer that is coextensive with the second surface, and a release liner coupled to the adhesive layer.

In some embodiments, a body adhesion device comprises a first surface opposite a second surface, the first surface comprising a first elevated element, a second elevated element, and a channel therebetween, wherein the channel has a first width and a second width that is wider than the first width such that a microphone may be secured within the channel through insertion of the microphone past the first width and into the channel, the first width being less than a diameter of the microphone and/or cable such that the microphone remains secured in the channel in the second width; the second surface comprising an adhesive layer that is coextensive with the second surface, and a release liner coupled to the adhesive layer.

In some embodiments, a method for adhering a microphone, tube, or cable to a user's skin comprises removing a release liner from a body adhesion device, placing the adhesive layer of the body adhesion device firmly against a user's skin, and inserting a microphone, tube, or cable into a channel of the body adhesion device until the microphone, tube, or cable is secured within the channel of the body adhesion device. It will be appreciated that the microphone, tube, or cable may also be inserted into the body adhesion device prior to coupling to a user's skin.

In some embodiments, a method of making a body adhesion device comprises coupling together a first half and a second half of an injection mold for a body adhesion device, inserting a plurality of rods into the injection mold, injecting heated pellets of silicon or synthetic resin into cavities of a mold for the body adhesion device, cooling the mold, removing the plurality of rods that have formed a channel of the body adhesion device, ejecting the body adhesion device from the mold, adhering an adhesive layer to the second surface, and adhering a release liner to the adhesive layer. While silicone pellets were used as an example herein, it will be appreciated that other substances and methods may also be used, including mixtures (e.g., one-to-one mixtures).

### BRIEF DESCRIPTION OF THE DRAWINGS

FIG. 1 illustrates a right-side elevation view of a body adhesion device;

FIG. 2 illustrates a top plan view of a body adhesion device;

FIG. 3 illustrates a front, right-side perspective view of a body adhesion device;

FIG. 4 illustrates a top plan view of a body adhesion device next to a lavalier microphone;

FIG. 5 illustrates a right-side elevation view of a body adhesion device next to a lavalier microphone;

FIG. 6 illustrates a right-side elevation view of a body adhesion device coupled to a lavalier microphone;

FIG. 7 illustrates a top plan view of a body adhesion device;

FIG. 8 illustrates a left-side perspective view of a body adhesion device adhered to a user's face;

FIG. 9 illustrates a top, side perspective view of a first half of an injection mold for a body adhesion device; and

FIG. 10 illustrates a bottom, side perspective view of a second half of an injection mold for a body adhesion device.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a reliable means of adhering a microphone, tube, or cable to a user's body that also allows the user to easily remove and replace the microphone, tube, or cable during use. The body adhesion device disclosed herein solves these needs and others.

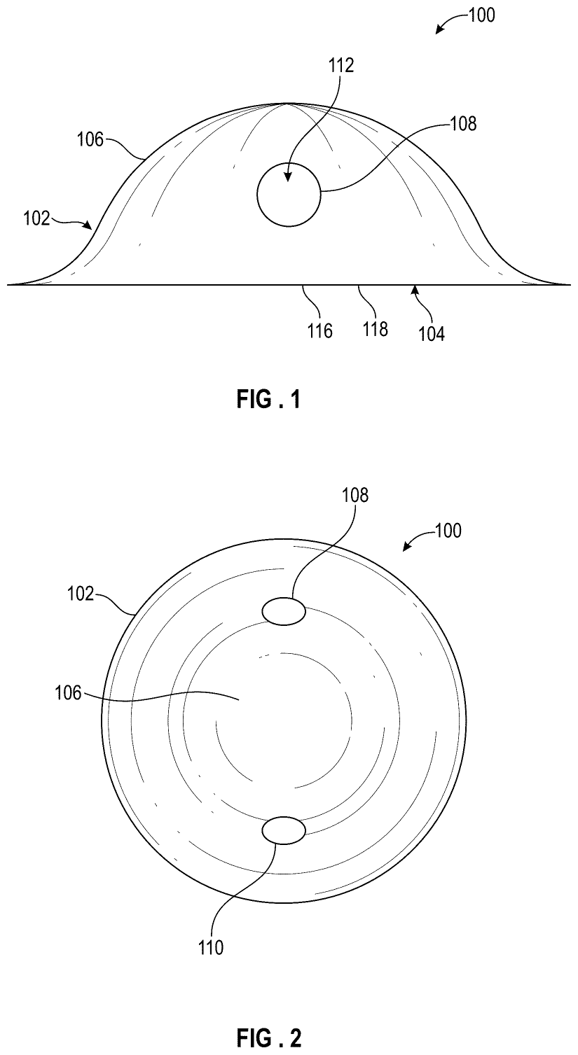

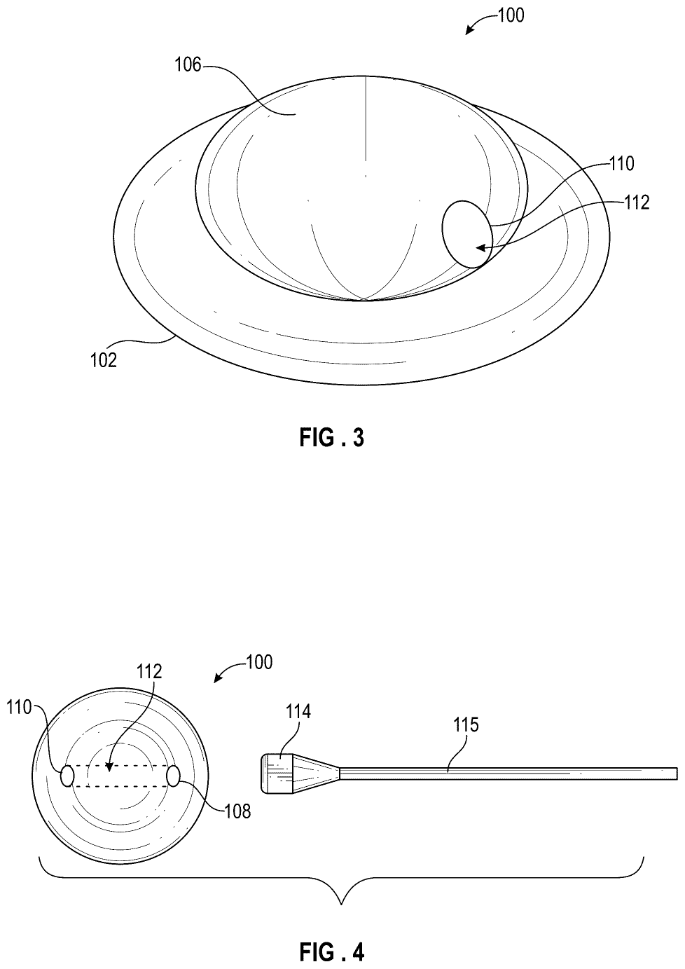

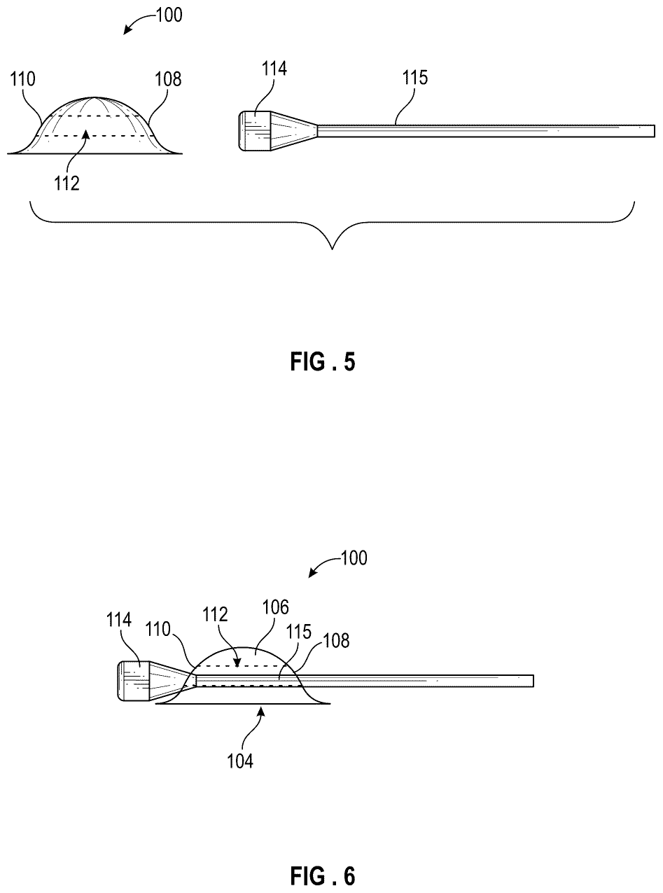

In some embodiments, as shown in FIGS. 1-6, a body adhesion device 100 comprises a first surface 102 opposite a second surface 104, the first surface 102 comprising an elevated element 106, a first aperture 108, a second aperture 110, and a channel 112 therebetween. As shown, the channel 112 may have a single diameter for its entire length. Because the body adhesion device 100 is made from silicone (e.g., Ecoflex 00-50) or similar materials, the apertures 108, 110 and channel 112 may flex to allow a microphone 114 to pass therethrough. However, in some embodiments, the first aperture 108 may have a larger diameter than the second aperture 110 such that a microphone 114 may be more easily inserted through the first aperture 108 and channel 112 and forced out of smaller, second aperture 110. Because second aperture 110 may be smaller in diameter, the microphone 114 is prohibited from easily passing back therethrough. However, even where the apertures 108, 110 are the same diameter, that diameter may be smaller than the head of the microphone 114, thereby reducing or preventing unintentional withdrawal of the microphone 114. Once the head passes out the second aperture 110, the cable 115 is secured in the channel 112. Additionally, the second surface 104 comprises an adhesive layer 116 that is coextensive with the second surface 104, and a release liner 118 coupled to the adhesive layer 116 to protect the adhesive layer 116 until ready for use.

Accordingly, a user may peel off the release liner 118 and firmly place the adhesive layer 116 (which may be Avery-Dennison FT 9302 SF, or any suitable adhesive for removably adhering to the skin) of the body adhesion device 100 on any surface of the user's face or body. The adhesive layer 116 may feature a water-resistant adhesive that resists peeling off as a user sweats. A microphone 114 may then be secured in place through insertion into the channel 112. While a microphone 114 is shown, it will be appreciated that any similar device may be inserted therethrough, such as a cable, tube, or other device. As mentioned earlier, it will be appreciated that due to the semi-rigid nature of the material used, for example, silicon or synthetic resin, the channel 112 may expand to insert the microphone 114 into the channel 112 and then immediately return to its natural state to mitigate removal of the microphone 114 without intentional force applied by the user.

Moreover, a user may adhere one or more body adhesion devices 100 at intervals along the user's skin. For example, a user may adhere a body adhesion device on the face, the back of the neck, and the small of the back, wherein the first device 100 on the face holds the microphone 114 while the second and third devices 100 along the neck and back hold the cable of the microphone 114, thus increasing stability of the system between the microphone 114 and the input to the microphone transmitter, typically secured to the waist of a user's pants.

In some embodiments, a microphone adhesion 100 device is three-quarters of an inch long with a channel 112 that is about two millimeters wide and half an inch long. It will be appreciated that the above dimensions create a body adhesion device 100 having about a gram or less in weight and is very light when applied to the face or body and is discreet in appearance. For example, the Ecoflex silicone is non-toxic and may have a specific gravity of 1.07 gg/cc, making it suitable for use on a person's skin and extremely lightweight. Moreover, the diameter of the channel 112 will accommodate the insertion and removal of most traditional lavalier microphones on the market. While specific measurements are given in this example, it will be appreciated that the body adhesion device 100 is not limited to these dimensions and may vary therefrom.

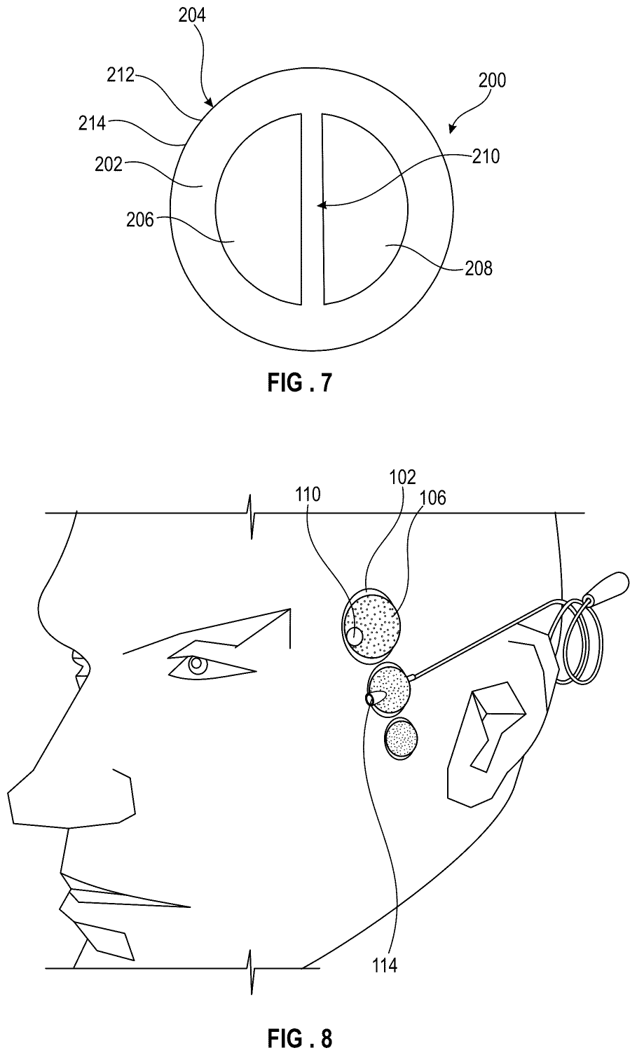

In some embodiments, as shown in FIG. 7, a body adhesion device 200 comprises a first surface 202 opposite a second surface 204 (the underside), the first surface 202 comprising a first elevated element 206, a second elevated element 208, and a channel 210 therebetween. In some embodiments, the channel 210 comprises a first width at the top of the first and second elevated elements 206, 208 and comprises a second width at the base of the first and second elevated elements 206, 208 that is wider than the first such that a microphone cable 115 may be secured within the channel 210 through insertion of the microphone cable 115 past the first width and into the channel 210. Because the first width is less than a diameter of the microphone cable 115, the microphone cable 115 remains secured in the channel 210 unless intentional force is applied to remove it. Additionally, the second surface 204 comprises an adhesive layer 212 that is coextensive with the second surface 204, and a release liner 214 coupled to the adhesive layer 212.

FIG. 8 illustrates that the overall size and placement of the body adhesion device 100 may vary without departing herefrom.

In some embodiments, a method for adhering a microphone 114 or tube or cable to the skin comprises removing a release liner 118 from a second surface 104 of the body adhesion device 100, placing the adhesive layer 116 of the body adhesion device 100 on a user's skin, and inserting a microphone 114 through the first aperture 108, through a channel 112, an out a second aperture 110 such that the microphone cable 115 is secured within the channel 112 and the microphone 114 is prohibited entering the second aperture 110 once again absent the presence of force (e.g., a user pulling the cable 115 to withdraw the microphone 114). A user may also remove the microphone, tube, or cable by pulling or otherwise withdrawing the microphone, tube, or cable from the body adhesion device 100. This allows a user to remove the microphone, tube, or cable when not in use, but not remove the body adhesion device 100, allowing for easy insertion of the microphone, tube, or cable once again when ready for use. For example, a user in theatre may remove the microphone 114 when not on stage, without impacting makeup or costumes, and may easily reinsert the microphone 114 into the body adhesion device 100 when it is time to enter the stage again. This overcomes the problems in the art noted earlier.

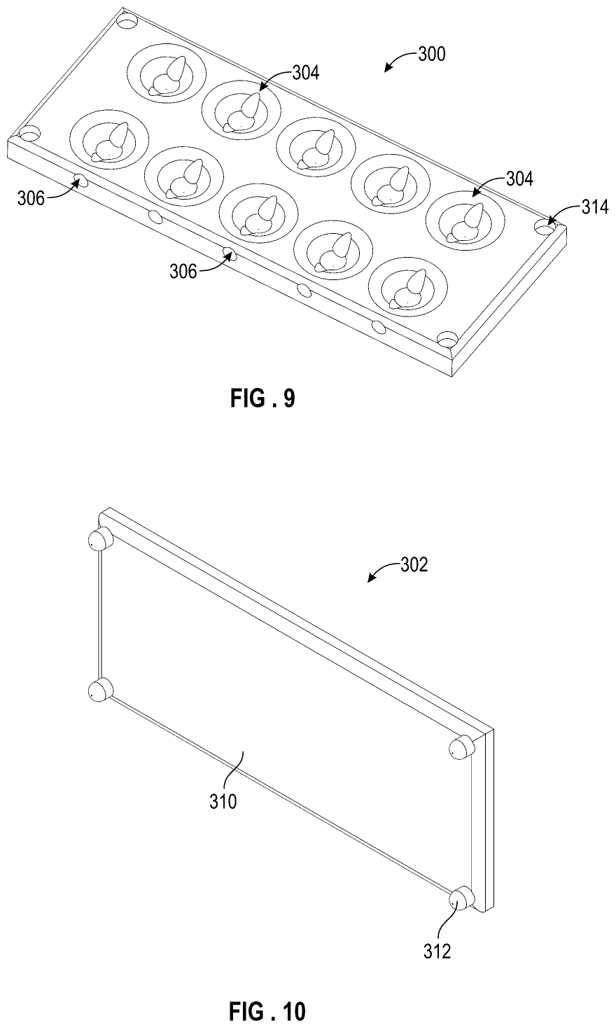

In some embodiments, as best seen in FIGS. 9-10, a method of making a body adhesion device 100 comprises coupling together a first half 300 and a second half 302 of an injection mold for a body adhesion device 100, wherein the first half 300 comprises a plurality of cavities 304, one or more apertures 306 on a lateral side, one or more corresponding apertures (not visible) along an opposite lateral side of the first half 300, and the second half 302 comprising a flat top surface 310. The flat top surface 310 may comprise alignment protrusions 312 for mating with the alignment apertures 314 on the first half 300. A rod (not shown) may be inserted to extend through the first apertures 306 to the second apertures, the rod forming the negative space for the channel 112 of the body adhesion device 100. A user may then inject silicone or synthetic resin into cavities 304 of the injection mold for the body adhesion device 100, cool the mold, remove the rod by withdrawing it from the apertures 306, and eject the body adhesion device 100 from the mold. The user may then adhere an adhesive layer to the second surface 104, and adhere a release liner 118 to the adhesive layer 116. While an example of manufacture is given above, it will be appreciated that other methods of manufacture known in the art of silicone injection may be used without departing herefrom.

As noted earlier, the prior art requires that users completely remove tape when removing a microphone, tube, cable, or other body-worn device, which pulls at the skin and often leaves residue. This is not only uncomfortable for a user, but when a user returns to the stage, the user must retouch any makeup, wigs, hats or prosthetics that were disturbed when removing and reapplying the tape for the microphone. In contrast, because the microphone 114 is removable from the body adhesion device 100, 200, a user may remove the microphone 114 without interfering with makeup, costumes, or other items while leaving the body adhesion device 100 coupled to the user's skin. The user may then reinsert the microphone 114 into the channel 112 when returning to stage. Because the contact area is so small, pulling on the skin is significantly reduced as compared to the tape described above, and the medical-grade adhesive reduces or eliminates any potential residue on the skin. The same is true of medical fields or other industries. Additionally, the adhesive may be optimized for adhesion to skin and be water- and sweat-resistant to last an entire performance or as required in medical settings. Accordingly, the body adhesion device overcomes the limitations of the prior art.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A body adhesion device, comprising:
a first surface comprising:
an elevated element,
a first aperture,
a second aperture,
and a channel connecting the first aperture to the second aperture, the channel extending through the elevated element;
a second surface opposite the first surface, the second surface comprising:
an adhesive, and
a release liner coupled to the adhesive.

2. The body adhesion device of claim 1, wherein the first aperture and second aperture are configured to be smaller in diameter than a microphone, tube, or cable to be received therethrough.

3. The body adhesion device of claim 1, wherein the first aperture, second aperture, and channel are configured to flex in size to receive a microphone, tube, or cable therethrough.

4. A body adhesion device, comprising:
a first surface comprising:
a first elevated element separated from a second elevated element by a channel;
a second surface opposite the first surface, the second surface comprising:
an adhesive, and
a release liner coupled to the adhesive.

5. The body adhesion device of claim 4, wherein the channel has a first width at a top of the channel, and a second width less than the first width at the bottom of the channel.

6. The body adhesion device of claim 5, wherein the channel is flexible under pressure so as to receive a cable or tube therein, the first width configured to be smaller than the width of a cable or tube to be received therein.

7. A method of using a body adhesion device, the method comprising:
peeling a release liner from an adhesive layer;
placing a microphone, tube, or cable in a channel of the body adhesion device;
placing the adhesive layer on the skin an individual.

8. The method of claim 7, further comprising removing the microphone, tube, or cable by withdrawing the microphone, tube, or cable from the channel.
